(19) United States
(12) Patent Application Publication
(10) Pub. No.: US 2026/0295331 A1
(43) Pub. Date: Oct. 1, 2026

(54) HIP SUPPORT ASSEMBLY FOR PROCUMBENT EXERCISE APPARATUS

(71) Applicants: Mary Williams, Billings, MT (US); Jonathan David Yaffe, Tucson, AZ (US)

(72) Inventors: Mary Williams, Billings, MT (US); Jonathan David Yaffe, Tucson, AZ (US)

(21) Appl. No.: 19/635,765

(22) Filed: Mar. 31, 2026

Related U.S. Application Data
(60) Provisional application No. 63/780,782, filed on Mar. 31, 2025.

(51) Int. Cl. A63B 22/06; A63B 21/00; B62K 3/00

(52) U.S. Cl. CPC A63B 22/0694; A63B 21/4039; A63B 22/0605; B62K 3/005; A63B 2022/0652; A63B 2225/093

(57) ABSTRACT

A hip support assembly includes a frame member coupled to a main frame of the exercise apparatus, a stem coupled to a top end of the frame member, a tube coupled to a top end of the stem and a first saddle and a second saddle. Each of the first and second saddles includes a pad for supporting an iliac crest of the user, and a base coupling the first and second saddles to the tube. The hip support assembly is longitudinally, laterally, vertically and rotationally adjustable and supports the hips (particularly the iliac crests) of a user during use of an exercise apparatus in a procumbent position.

### CROSS-REFERENCE TO RELATED APPLICATION

The present application is related to and claims priority to U.S. Provisional Patent Application Number 63/780,782 filed Mar. 31, 2025, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of exercise apparatus of existing art and more specifically relates to a hip support assembly for a procumbent exercise apparatus.

### RELATED ART

Bicycles and e-bikes have been in widespread use for well over a century, yet the fundamental design of the rider's seat has remained largely unchanged. The conventional bicycle seat is a narrow, elongated seat upon which the rider perches with full bodyweight concentrated across a small contact area. Despite iterative refinements in materials, padding, and contour, the underlying geometry of this design continues to impose serious anatomical, ergonomic, and safety-related shortcomings that remain unresolved in the prior art.

A primary and well-documented deficiency of the conventional seat is the direct, sustained pressure it exerts upon the coccyx (tailbone) and the surrounding soft tissue of the pelvic floor. The coccyx, being a vestigial structure at the terminus of the vertebral column, is not designed to bear prolonged compressive loading. Riders commonly experience acute coccydynia (pain and inflammation of the coccyx) following extended periods of use. Existing attempts to mitigate this problem, such as cut-out channels or relief grooves in the seat surface, provide only marginal relief and fail to eliminate the root cause of coccygeal compression.

Compounding this issue is the sustained and uncomfortable contact of the rider's inner thighs against the lateral edges of the seat. The conventional shape forces the rider's thighs inward and into repeated frictional contact with the seat body during the pedaling motion. This repeated mechanical rubbing causes chafing, skin irritation, and in chronic cases, saddle sores open or inflamed lesions on the skin of the inner thigh and perineal region. This condition, colloquially referred to as “monkey butt” among cyclists, represents a persistent and painful deterrent to extended riding and is especially prevalent among e-bike commuters who ride for prolonged durations without the athletic conditioning of competitive cyclists. No seat design currently available on the market has successfully eliminated this problem at the structural level.

Beyond soft tissue discomfort, the conventional seat fails to provide adequate biomechanical support for active vehicle control. Because the rider is perched atop a narrow-elevated point of contact, lateral weight transfer, essential for initiating and completing turns, is significantly restricted. The rider cannot effectively shift body mass to the inside of a corner, reducing cornering agility and requiring greater handlebar input to achieve directional changes. This limitation becomes particularly consequential at the higher speeds enabled by electric-assist drivetrains on modern e-bikes, where dynamic cornering demands are increased relative to traditional pedal-only bicycles.

The conventional seat also contributes to upper extremity injury through an indirect but well-established mechanism. Because the rider's seat provides no meaningful fore-aft retention during deceleration, the rider's body is prone to sliding forward under braking forces. To counteract this tendency, riders habitually brace themselves against the handlebars, effectively transferring braking forces through the wrists, forearms, and shoulders. This habitual bracing leads to overuse injuries including carpal tunnel syndrome, wrist tendinopathy, and shoulder impingement, particularly in riders who commute frequently or navigate stop-and-go urban traffic. The handlebar thus bears an ergonomic burden that would be substantially reduced if the seating system itself provided adequate rider retention.

A further serious deficiency of the conventional seat relates to rider ejection during frontal collisions. In the event of a sudden stop or frontal impact, the rider's inertia carries the body forward and upward off the seat, frequently resulting in ejection over the handlebars. Because the saddle provides no structural interface that retains the rider's pelvis or lower body, there is no mechanism to absorb or redirect this forward momentum. Ejected riders sustain a disproportionate frequency of upper body injuries, including wrist fractures from outstretched-arm impact, clavicle fractures, cervical spine injuries, and traumatic brain injury.

Thus, problems exist in the current art that cause rider pain and injury, including coccygeal compression, sores from inner thigh friction, overuse injuries to the wrists and arms from compensatory handlebar bracing, and severe upper body trauma resulting from forward ejection during collision events. These deficiencies are further compounded by the conventional seat's failure to provide adequate lateral body coupling, limiting cornering agility and overall vehicle control.

### SUMMARY OF THE INVENTION

In view of the foregoing disadvantages inherent in the known art, the present disclosure provides a novel hip support system for an exercise apparatus, such as an exercise bike or an e-bike, that eliminates coccygeal compression, reduces inner thigh contact and friction, provides meaningful fore-aft rider retention, improves cornering agility through enhanced body-to-vehicle coupling, reduces upper extremity loading during braking, and mitigates the risk of forward ejection during collision events.

According to one or more embodiments, a hip support assembly for supporting hips of a user during use of an exercise apparatus in a procumbent position is disclosed herein. The hip support assembly may include a frame member coupled to a main frame of the exercise apparatus, a stem coupled to a top end of the frame member, a tube coupled to a top end of the stem and a first saddle and a second saddle, each of the first and second saddles including a pad for supporting an iliac crest of the user, and a base coupling the first and second saddles to the tube. According to one or more additional embodiments, the pad of the first and second saddles may be removably coupled to the base, thereby enabling selective replacement of the pad with one or more alternative pads having different properties (e.g., geometries, materials, thickness, etc.).

According to one or more additional embodiments still, an adjustable hip support assembly for supporting hips of a user during use of an exercise apparatus in a procumbent position is disclosed herein. The adjustable hip support assembly may include a frame member, a stem, a longitudinal adjustment mechanism, a tube, a first saddle, and a second saddle. The frame member may be coupled to a main frame of the exercise apparatus and includes a vertical adjustment mechanism for vertical adjustment of the hip support assembly relative to the main frame. The stem may be coupled to a top end of the frame member; in particular, the longitudinal adjustment mechanism may couple the stem to the frame member and includes a longitudinal adjustment of the hip support assembly relative to the main frame. The tube may be coupled to a top end of the stem and each of the first and second saddles may include a pad for supporting an iliac crest of the user, and a base coupling the first and second saddles to the tube. The first and second saddles may be configured to be independently rotated about the tube for rotational adjustment thereof and further configured to be independently translated along the tube for lateral adjustment thereof.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hip support assembly for a procumbent exercise apparatus, constructed and operative according to the teachings of the present disclosure.

FIG. 1 is a rear perspective view of a hip support assembly including a stem, a tube, and a first and second saddle, according to an embodiment of the disclosure.

FIG. 2 is a front view of the first and second saddle of the hip support assembly, according to an embodiment of the present disclosure.

FIG. 3 is a rear perspective illustrating the hip support assembly on an e-bike, according to an embodiment of the present disclosure.

FIG. 4 is a side view illustrating a frame member coupled with a frame of the e-bike of FIG. 3, according to an embodiment of the present disclosure.

FIG. 5 is a side view demonstrating longitudinal and rotational adjustment capabilities of the hip support assembly, according to an embodiment of the present disclosure.

FIG. 6 is a side view illustrating the hip support assembly on an exercise bike, according to an embodiment of the present disclosure.

FIG. 7 is a side view demonstrating longitudinal, vertical and rotational adjustment capabilities of the hip support assembly, according to an embodiment of the present disclosure.

The various embodiments of the present invention will hereinafter be described in conjunction with the appended drawings, wherein like designations denote like elements.

### DETAILED DESCRIPTION

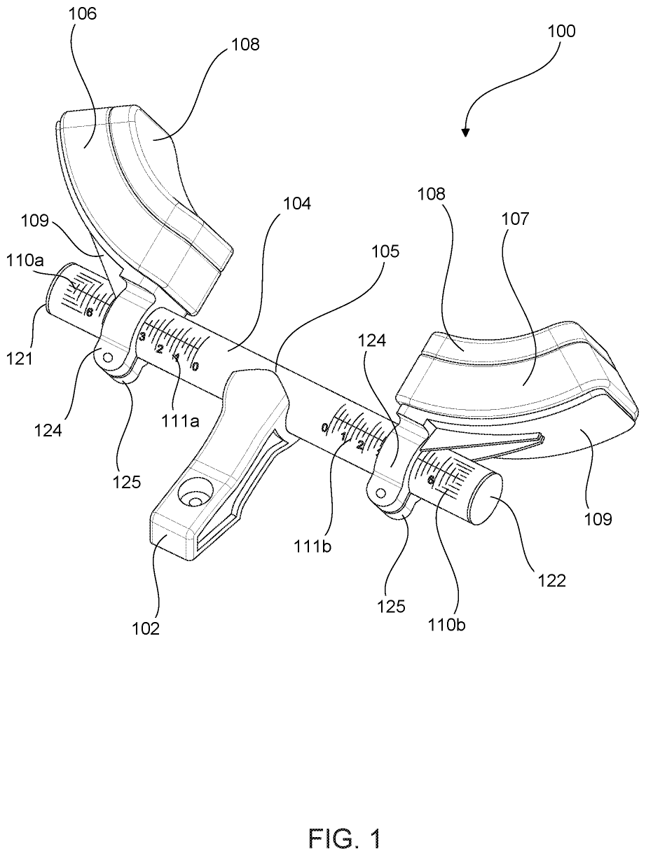

Referring now more specifically to the drawings by numerals of reference, there are shown in FIGS. 1-7, various views of a hip support assembly 100 for supporting hips of a user during use of an exercise apparatus 5 in a procumbent position. The hip support assembly 100 is particularly suited for a procumbent exercise apparatus 5, and more particularly, a procumbent e-bike and/or exercise bike. However, it should be appreciated that the hip support assembly 100 may have applicability to other exercise apparatus 5 and other vehicles. For example, cycle, bicycle, motorcycle, tricycle, scooter, moped, etc.; in other words, any vehicle containing two or three wheels that moves upon the ground and is controlled by a rider. This vehicle may be human powered, powered by electricity only, or by combination of fuels, electricity and human muscles.

Procumbent can be construed to mean a position in which a human body is pitched forward from a standing position (i.e., vertical/plumb) and feet are rearward of body's center of mass. A procumbent angle is calculated as average of torso angle and control angle, where control angle is line through hand hold to ball of foot, at leg(s) most extended position.

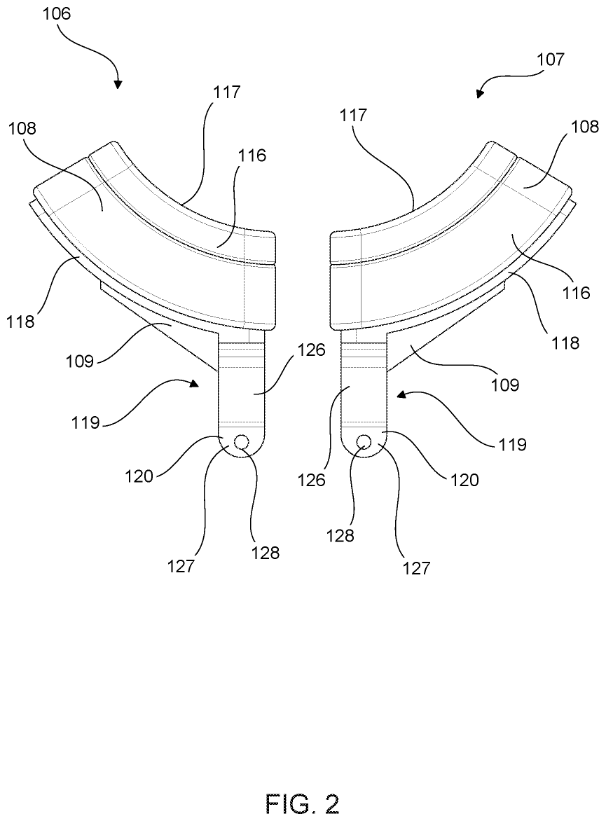

Referring first to FIG. 1, which is a rear perspective view of the hip support assembly 100 and FIG. 2, which is a front view of a first saddle 106 and a second saddle 107 of the hip support assembly 100, according to one or more embodiments of the present disclosure. As shown here, the hip support assembly 100 may include a stem 102, a tube 104, a first saddle 106 and a second saddle 107. The stem 102 may couple to a frame member 101 of the hip support assembly 100 (which will be discussed in more detail below) at a bottom end 133 of the stem 102; and the tube 104 may be coupled to a top end 105 of the stem 102. In some examples, the top end 105 of the stem 102 includes a clamp 120 defining a cradle for receiving the tube 104 therein. The tube 104 includes an elongated, cylindrical configuration including a first end 121 opposite a second end 122 and a longitudinal axis 123 extending between the first end 121 and second end 122 that spans laterally across the exercise apparatus 5.

The first saddle 106 and the second saddle 107 are coupled to the tube 104 and spaced apart-the first saddle 106 being positioned toward the first end 121 of the tube 104 and the second saddle 107 being positioned toward the second end 122 of the tube 104. Each of the first saddle 106 and second saddle 107 include a pad 108 for supporting (e.g., cradling) an iliac crest of the user. The first saddle 106 and second saddle 107 may each be oriented such that they curve downwardly and inwardly to conform to the iliac crest of the user (of the ilium bones). The ilium is the largest of the three bones that fuse together to form the pelvis, sitting on either side of the sacrum like a pair of broad, wing-shaped structures. The uppermost ridge of the ilium is called the iliac crest, which forms a curved bony prominence, running from the front of the pelvis to the back, ending in the anterior and posterior superior iliac spines. The iliac crest serves as a major attachment site for muscles of the abdomen, back, and gluteal region. This support/cradling of the iliac crest provides benefits in rider ergonomics and vehicle control, as compared to conventional seats that contact the coccyx and inner thighs, and also removes pain associated with sitting on bike seats. In some embodiments, the pad 108 comprises multi-layer foam and/or gel cushioning for cushioning the iliac crests.

With iliac crests resting on the first saddle 106 and second saddle 107, the user has firm side-to-side (i.e., lateral) connection with the exercise apparatus 5, which improves cornering agility and provides natural ability to slalom for thrill and obstacle avoidance, by differing body weight through leaning into the first saddle 106 and second saddle 107. Further, the user's abdomen (i.e., center of gravity) is restrained from unintentionally moving forward, relative to the exercise apparatus 5, during braking and low-speed frontal collisions, thereby reducing common hand, wrist and arm pain from frequent braking and reducing upper body injuries sustained during low-speed collisions in conventional bikes, where the user is rejected forward off of the seat.

In some embodiments of the present disclosure, the pad 108 of each of the first saddle 106 and second saddle 107 is removable from the base 109. This removability enables interchangeability between one or more alternative pads having different properties, such as (but not limited to) different geometries, materials, thickness, etc. For example, in some embodiments, the pad 108 includes an arcuate body 116 forming a concave top surface 117 for cradling the iliac crest of the user, supporting and centering a body of the user. Other pads can include, for example, planar surfaces, varying levels of concavities, varying thicknesses, varying materials, etc.

Each of the first saddle 106 and second saddle 107 further comprise the base 109 coupling the first saddle 106 and second saddle 107 to the tube 104. The base 109 of each of the first saddle 106 and second saddle 107 may comprise a support portion 118 and a clamp portion 119. As shown here, the support portion 118 may be secured to and supporting the pad 108. In some embodiments, the support portion 118 includes a plate including a curvature corresponding to a curvature of the pad 108. The clamp portion 119 extends from the support portion 118 (downwardly therefrom) and is configured to circumferentially engage the tube 104. In some embodiments, as shown here, the clamp portion 119 may include a C-clamp or a U-clamp comprising a first half 124 and a second half 125 disposed opposite each other. Each half 124, 125 includes a curved section 126 able to conform to the curvature of the tube 104 and a flange 127 extending down past a bottom of the tube 104, with a central aperture 128 for receiving a bolt or other fastener for securing the clamp portion 119 to the tube 104.

The hip support assembly 100 preferably includes multi-axis adjustability. Particularly, vertical, longitudinal, lateral and rotational adjustability. The first saddle 106 and second saddle 107 may be configured to be independently rotated about the tube 104 for rotational adjustment thereof. This may be achieved by unfastening the clamp portion 119 (partially or wholly) from the tube 104 and rotating the first and/or second saddle 107 about the longitudinal axis 123 of the tube 104 to a desired position. Further, the first saddle 106 and second saddle 107 may be configured to be independently translated along the tube 104 for lateral adjustment thereof. Again, this may be achieved by unfastening the clamp portion 119 (partially or wholly) from the tube 104 and translating (e.g., sliding) the first and/or second saddle 107 along the longitudinal axis 123 of the tube 104 to the desired position.

As best shown in FIG. 1, the tube 104 may include a first set of positioning indicia 110 a, 110 b (or ‘registration marks’) and a second set of positioning indicia 111 a, 111 b to aid in guiding the adjustment of the first saddle 106 and second saddle 107. In particular, the first set of positioning indicia 110 a, 110 b enables visual guidance of the rotational adjustment of the first saddle 106 and second saddle 107. As shown in FIG. 1, indicia 110 a is disposed at the first end 121 of the tube 104 for enabling visual guidance of the rotational adjustment of the first saddle 106, and indicia 110 b at the second end 122 of the tube 104 for enabling visual guidance of the rotational adjustment of the second saddle 107. In a non-limiting example, the first set of positioning indicia 110 a, 110 b may include incremental line markings.

The second set of positioning indicia 111 a, 111 b enables visual guidance of the lateral adjustment of the first saddle 106 and second saddle 107. As shown in FIG. 1, indicia 111 a is disposed toward the first end 121 of the tube 104, adjacent indicia 110 a, for enabling visual guidance of the lateral adjustment of the first saddle 106, and indicia 111 b is disposed toward the second end 122 of the tube 104, adjacent indicia 110 b, for enabling visual guidance of the lateral adjustment of the second saddle 107. In a non-limiting example, the second set of positioning indicia 111 a, 111 b may include (but is not limited to) a graduated scale with increments of 0-6 inches.

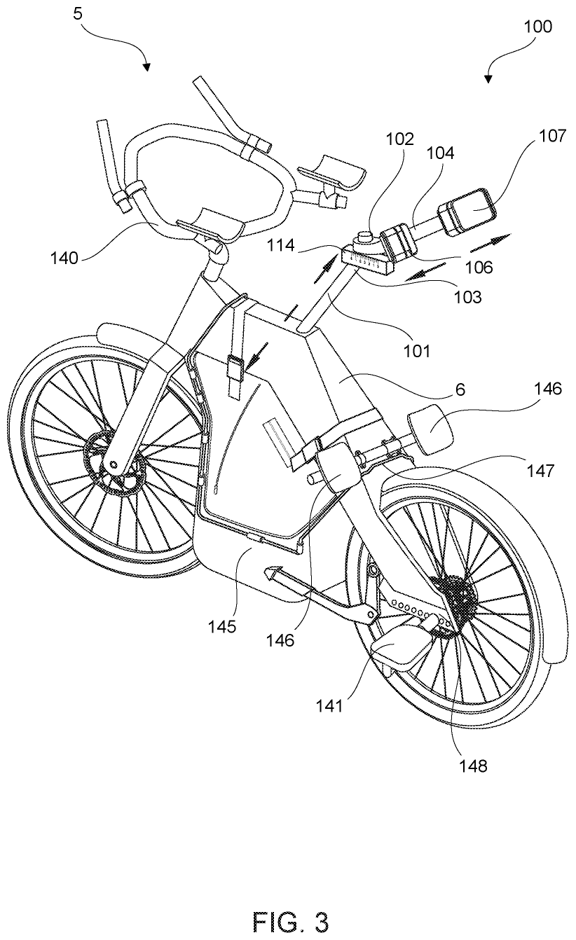

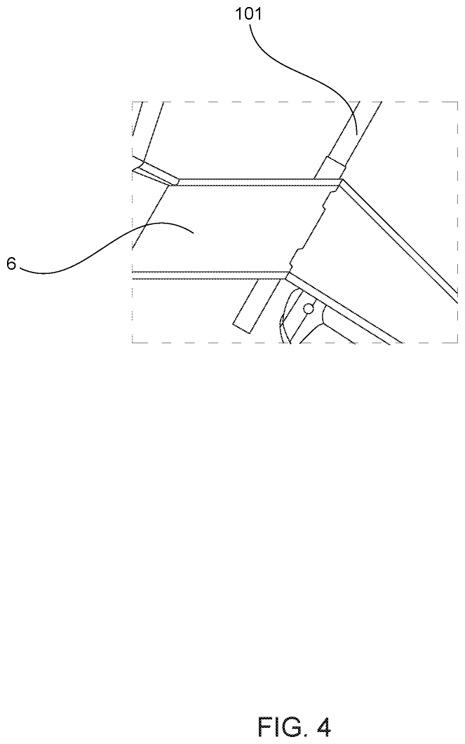

FIG. 3 is a rear perspective view illustrating the hip support assembly 100 attached to an e-bike, according to one more embodiments of the present disclosure. As shown here, the hip support assembly 100 further includes the frame member 101 coupled to a main frame 6 of the e-bike. The stem 102 may be coupled to or about a top end 103 of the frame member 101. In some embodiments, the frame member 101 includes a post. As best shown in FIG. 4, which is a side view of the main frame 6 of the e-bike, the post may insert through the main frame 6 of the e-bike. In some embodiments, the post may enable vertical adjustment of the hip support assembly 100, by adjusting insertion of the post through the main frame 6.

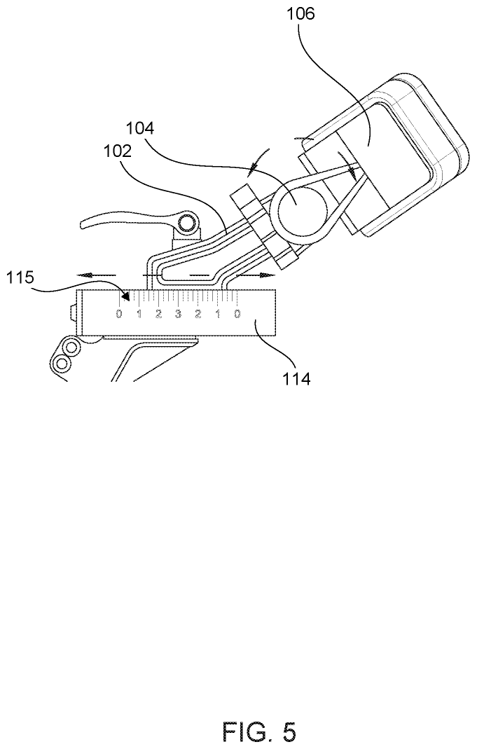

FIG. 5 is a close-up side view illustrating rotational and longitudinal adjustment of the hip support assembly 100 according to the e-bike embodiment. As shown here, in some embodiments, the hip support assembly 100 further comprises a longitudinal adjustment mechanism 114. The longitudinal adjustment mechanism 114 may couple the stem 102 to the frame member 101 (e.g., post in this embodiment), or is at least in communication with the stem 102. The longitudinal adjustment mechanism 114 may enable longitudinal adjustment of the hip support assembly 100 relative to the main frame 6. Similar to above, to aid in this, the longitudinal adjustment mechanism 114 may include a fourth set of positioning indicia 115, enabling visual guidance of the longitudinal adjustment. For example, the fourth set of positioning indicia 115 may include (but is not limited to) a graduated scale with increments of 0-6 inches.

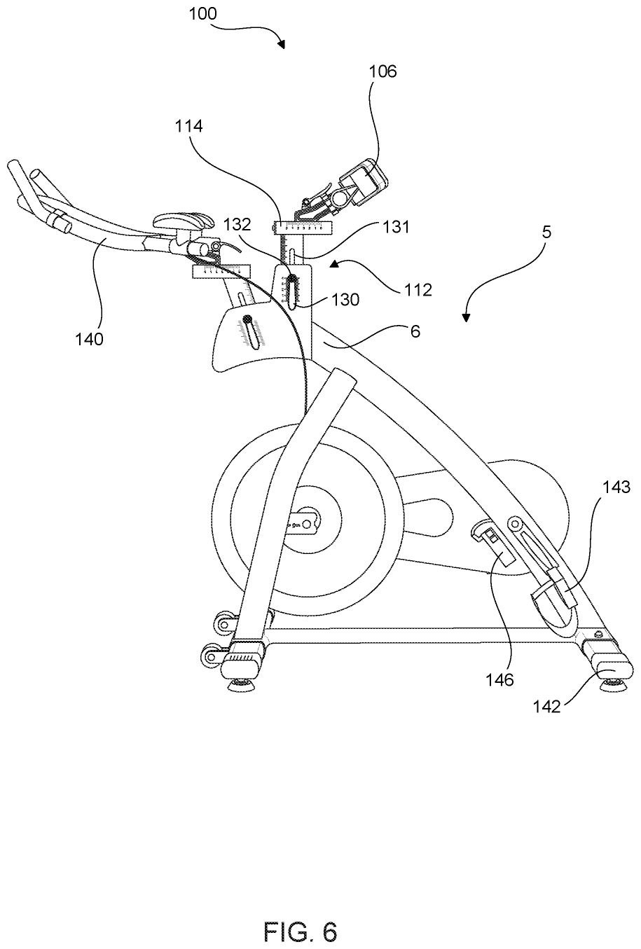

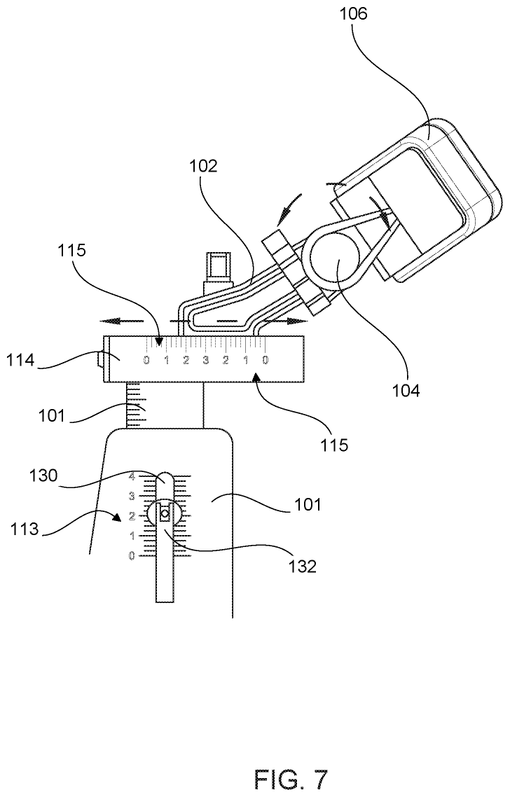

FIG. 6 is a side view of the hip support assembly 100 coupled with an exercise bike, and FIG. 7 is a close-up side view demonstrating vertical, lateral and rotational adjustment capabilities of the hip support assembly 100 of the exercise bike embodiment. In this embodiment, the frame member 101 member may include a vertical adjustment mechanism 112 for vertical adjustment of the hip support assembly 100 relative to the main frame 6. In particular, the frame member 101 may telescope, or otherwise, slide/insert into the main frame 6 of the exercise bike, enabling vertical adjustment of the hip support assembly 100. As shown here, the main frame 6 includes a vertical, elongated opening 130, and the frame member 101 too includes a vertical elongated opening 131 aligned with the opening 130 in the main frame 6. A lock 132, or other means, is inserted through both openings 131, 130 and the sliding of the frame member 101 relative to the main frame 6 enables the frame member 101 to be locked at a desired position.

The frame member 101 and/or the main frame 6 may include a third set of positioning indicia 113 a, 113 b, enabling visual guidance of the vertical adjustment. Both the frame member 101 and the main frame 6 are shown FIG. 6 and FIG. 7 including the third set of positioning indicia (113 a, and 113 b, respectively). In some embodiments, the third set of positioning indicia 113 may include (but is not limited to) a graduated scale with increments of 1-5 inches.

The hip support assembly 100 supports the hips of the user during use of the exercise apparatus 5 in the procumbent position, which increases human power generation for pedaling applications, improves abdominal/pelvic/torso ergonomics and increases bike range through reduced aerodynamic drag. The exercise apparatus 5 may include orbital handlebars 140, adjustable platforms 141 and/or pedals 143, a novel mount and dismount method, knee pads 146 (FIG. 3), and a below frame storage compartment 145.

The orbital handlebars 140 may be closed and oblong or circular (360 degree) in shape, and provides the user with a new engagement with exercise apparatus 5 by allowing multiple hand positions, thereby improving rider ergonomics, allowing for rider orientation variations and providing mounting for add-on accessories (e.g., centered storage bags, electronic computers, displays, etc.). The orbital handlebars 140 may be specifically shaped for advanced human interaction and rider adjustability and includes multiple hand positions and elbow supports. For example, outer bull bars, upper aero position, elbow pad supports, a lower area for adjustment markings along with a top area for accessory mountings. The orbital handlebars 140 may be configured for lateral adjustment, with registration marks for positioning elbow pads in and out; pitch adjustment with registration marks for positioning elbow pads up and down; pitch adjustment with registration marks for positioning elbow pads and/or orbital handlebars 140 up and down; longitudinal adjustment with registration marks for positioning orbital handlebars 140 front and back; vertical adjustment with registration marks for positioning orbital handlebars 140 up and down; and lateral adjustment with registration marks for positioning elbow pads in and out.

The adjustable platforms 141 or pedals 143 are mounted behind the rider's center of gravity (i.e., hips) near rear of bike and provide body weight support, allow for mount/dismount of bike from back and when used with hipsters allow for procumbent position.

The novel mount and dismount method is aided through application of the hip support assembly 100 of the present disclosure and the adjustable platforms 141 or pedals 143. A new method to mounting (i.e., “step-on”) and dismounting (i.e., “step-off”) the exercise apparatus 5 is attained by providing rear platforms 141, or rear pedals 143 for rider's feet to be supported, without need to “step-over”, or “step-through” a frame, or seat, as commonly practiced with other bikes. This provides for less potential injury, due to human unbalance that may exist from lift one leg high while also rotating body.

Rear platforms 141 provide easy mount/dismount from a rear of the exercise apparatus 5 and allow increased dynamic control through lateral weight shifting of feet/hips (i.e., “differential steering”). The platforms 141 may be adjustable in a longitudinal direction (via an adjustment mechanism 148, as shown in FIG. 3) to accommodate different rider sizes or rider body position preference. Spacers may enable positioning using common bicycle pedals.

Rear pedals 143 provide easy mount/dismount and allow increased rotational power generation through reaction forces generated by contact with the hip support assembly 100 (by stabilizing the hips). The rear pedals 143 allow increased rotational power generation through contact with the orbital handlebars 140 (hands reduce body lift and allow more leg force by compressing body).

The knee pads 146 provide additional body weight support for reduction of human fatigue and allow for multi-directional adjustment with registration markings for positioning, to accommodate different rider sizes or rider body position preferences. For example, longitudinal adjustment, vertical adjustment, lateral adjustment and pitch adjustment.

The below frame storage compartment 145 provides an easily removal storage compartment 145 (i.e., cargo bag) with externally supported by an exoskeleton wire frame 147 hanging below bike's frame and in-between bike's wheels that provides improved vehicle dynamics (i.e., control, stability, cornering) when loaded with cargo by placing weight low to ground and between axii of wheels. This reduces common steer effects associated with widely used side-mounted, or high-mounted cargo bags (i.e., “paniers”), which are typically located above, or to side of bike's wheels, at either front or back, or both. The removable exoskeleton 147 may hook onto the frame of the exercise apparatus 5 for ease of install/removal. Removable straps may be secured over the frame of exercise apparatus 5 to support cargo weight and allow for fast removal and portability of the storage compartment 145. Pass through zippered opening may provide rapid access to cargo from either side of the exercise apparatus 5. The compartment may be expandable.

The embodiments described herein are exemplary in nature. Numerous modifications, variations, and rearrangements will be readily apparent to those skilled in the art, all of which are intended to fall within the spirit and scope of the invention. The scope of the invention is not limited to the specific embodiments disclosed, but extends to equivalent arrangements and to technologies developed in the future.

What is claimed is:

1. A hip support assembly for supporting hips of a user during use of an exercise apparatus in a procumbent position, comprising:
a frame member coupled to a main frame of the exercise apparatus;
a stem coupled to a top end of the frame member;
a tube coupled to a top end of the stem; and
a first saddle and a second saddle, each of the first and second saddles including a pad for supporting an iliac crest of the user, and a base coupling the first and second saddles to the tube.

2. The hip support assembly of claim 1, wherein the tube includes a first set of positioning indicia.

3. The hip support assembly of claim 2, wherein the first and second saddles are configured to be independently rotated about the tube for rotational adjustment thereof, and wherein the first set of positioning indicia enable visual guidance of rotational adjustment of the first and second saddles.

4. The hip support assembly of claim 2, wherein the tube includes a second set of positioning indicia.

5. The hip support assembly of claim 4, wherein the first and second saddles are configured to be independently translated along the tube for lateral adjustment thereof, and wherein the second set of positioning indicia enable visual guidance of the lateral adjustment of the first and second saddles.

6. The hip support assembly of claim 1, wherein the frame member includes a vertical adjustment mechanism for vertical adjustment of the hip support assembly relative to the main frame.

7. The hip support assembly of claim 4, wherein the frame member further includes a third set of positioning indicia, the third set of positioning indicia enabling visual guidance of the vertical adjustment.

8. The hip support assembly of claim 7, further comprising:
a longitudinal adjustment mechanism coupling the stem to the frame member, the longitudinal adjustment mechanism including a fourth set of positioning indicia; and
wherein the longitudinal adjustment mechanism enables longitudinal adjustment of the hip support assembly relative to the main frame; and
wherein the fourth set of positioning indicia enable visual guidance of the longitudinal adjustment.

9. The hip support assembly of claim 1, wherein the pad of each of the first and second saddles comprises an arcuate body forming a concave top surface for cradling the iliac crest of the user.

10. The hip support assembly of claim 1, wherein the first and second saddles are each oriented such that the arcuate body curves downwardly and inwardly to conform to the iliac crest of the user.

11. The hip support assembly of claim 1, wherein the base of each of the first and second saddles comprises:
a support portion secured to and supporting the pad; and
a clamp portion extending from the support portion and configured to circumferentially engage the tube.

12. The hip support assembly of claim 10, wherein the support portion includes a curvature corresponding to a curvature of the pad.

13. The hip support assembly of claim 1, wherein the pad of each of the first and second saddles is removable from the base.

14. A hip support assembly for supporting hips of a user during use of an exercise apparatus in a procumbent position, comprising:
a frame member coupled to a main frame of the exercise apparatus;
a stem coupled to a top end of the frame member;
a tube coupled to a top end of the stem; and
a first saddle and a second saddle, each of the first and second saddles including:
a pad for supporting an iliac crest of the user, and a base coupling the first and second saddles to the tube; and
wherein the pad is removably coupled to the base, thereby enabling selective replacement of the pad with at least one alternative pad.

15. The adjustable hip support assembly of claim 14, wherein the at least one alternative pad includes a different geometry than the replaced pad.

16. An adjustable hip support assembly for supporting hips of a user during use of an exercise apparatus in a procumbent position, comprising:
a frame member coupled to a main frame of the exercise apparatus, the frame member including a vertical adjustment mechanism for vertical adjustment of the hip support assembly relative to the main frame;
a stem coupled to a top end of the frame member;
a longitudinal adjustment mechanism coupling the stem to the frame member, the longitudinal adjustment mechanism enabling longitudinal adjustment of the hip support assembly relative to the main frame;
a tube coupled to a top end of the stem; and
a first saddle and a second saddle, each of the first and second saddles including a pad for supporting an iliac crest of the user, and a base coupling the first and second saddles to the tube;
wherein the first and second saddles are configured to be independently rotated about the tube for rotational adjustment thereof; and
wherein the first and second saddles are further configured to be independently translated along the tube for lateral adjustment thereof.

17. The adjustable hip support assembly of claim 16, wherein the tube includes a first set of positioning indicia, and wherein the first set of positioning indicia enable visual guidance of the rotational adjustment of the first and second saddles.

18. The adjustable hip support assembly of claim 16, wherein the tube includes a second set of positioning indicia, and wherein the second set of positioning indicia enable visual guidance of lateral adjustment of the first and second saddles.

19. The adjustable hip support assembly of claim 16, wherein the frame member further includes a third set of positioning indicia, the third set of positioning indicia enabling visual guidance of the vertical adjustment.

20. The adjustable hip support assembly of claim 16, wherein the longitudinal adjustment mechanism includes a fourth set of positioning indicia, and wherein the fourth set of positioning indicia enable visual guidance of the longitudinal adjustment.
